(19) United States
(12) Patent Application Publication
(10) Pub. No.: US 2020/0291545 A1
(43) Pub. Date: Sep. 17, 2020

(54) Device for the Extrusion of Filaments and for the Production of Spunbonded Fabrics

(71) Applicant: LENZING AKTIENGESELLSCHAFT, Lenzing (AT)

(72) Inventor: Ibrahim Sagerer-Foric, Vöcklabruck (AT)

(21) Appl. No.: 16/753,461

(22) PCT Filed: Oct. 3, 2018
(86) PCT No.: PCT/EP2018/076909

§ 371 Date: Apr. 3, 2020

(30) Foreign Application Priority Data
Oct. 6, 2017 (EP) 17195185.8

(51) Int. Cl. D01D 5/098; D01D 4/02; D01F 2/00; B29C 48/345; B29C 48/05; B29C 48/14

(52) U.S. Cl. CPC D01D 5/0985; D01D 4/025; D01F 2/00; B29K 2001/00; B29C 48/05; B29C 48/1472; B29C 2791/007; B29C 48/345

(57) ABSTRACT

A device (1) for the extrusion of filaments (2) comprising a plurality of extrusion capillaries (3) arranged in at least two consecutive rows and having extrusion openings (4) for extruding a spinning solution, whereby the filaments (2) are formed, and a plurality of components (7, 8, 10) for the generation of a gas stream for producing a gas stream oriented essentially in the direction of the extrusion of the filaments (2) at least in the area of the extrusion openings (4), wherein the extrusion capillaries (3) are arranged in extrusion columns (6) which protrude from a base plate (5) and are formed in one piece with said base plate (5).

### BACKGROUND OF THE INVENTION

### Field of the Invention

The invention relates to a device for the extrusion of filaments comprising a plurality of extrusion capillaries arranged in at least two consecutive rows and having extrusion openings for extruding a spinning solution, whereby the filaments are formed, and a plurality of means for the generation of a gas stream for producing a gas stream oriented essentially in the direction of the extrusion of the filaments at least in the area of the extrusion openings.

Furthermore, the invention relates to a method of manufacturing a device for the extrusion of filaments.

The present invention is a device for the extrusion of filaments and for the production of spunbonded fabrics which fulfills the requirement for a simplified manufacture, ease of assembly, high variety of design and a high throughput in that it can be made of a base material in one piece and is composed of sturdy extrusion columns which have a multi-row design and can be constructed in such a varied manner that high throughputs are rendered possible in the extrusion of fine filaments of geometrically different shapes from a variety of melts and solutions.

For several decades, various methods have been used with a wide variety of nozzles to produce fine fibres and filaments from a variety of polymer melts and solutions by means of a hot gas stream. The fibres and, respectively, filaments thus produced can then be deposited as a nonwoven fabric on a perforated surface, e.g., on a drum or on a conveyor belt. Depending on the method and the polymer used, the produced nonwoven fabric is then either wound up directly, or first aftertreated, before it is then wound up as a roll and finished for sale. So as to further reduce production costs, the increase in throughput and the reduction in the demand for energy, with an at least consistent quality of the nonwoven fabric, are the largest optimization areas in the industry of spunbonded webs.

As described in U.S. Pat. No. 3,543,332, for example, polyolefins, polyamides, polyesters, polyvinyl acetate, cellulose acetate and many other fusible or soluble substances may be used as raw materials. Processes have also been developed for the production of spunbonded webs from Lyocell dope, as described in U.S. Pat. Nos. 6,306,334, 8,029,259 and 7,922,943. As another example, the production of spunbonded webs from starch is described in U.S. Pat. No. 7,939,010. Since, in parts, the raw materials used very greatly in their properties, especially in rheology, the requirement for flexibility and adaptability of the nozzle design increases.

The nozzles used so far for the production of spunbonded fabrics by the meltblown process can be roughly divided into single-row and multi-row nozzles.

Single-row nozzles, as described in U.S. Pat. No. 3,825,380, can indeed be used for the production of spunbonded fabrics from melts and solutions, but, depending on the viscosity of the melt or, respectively, the solution, the pressure loss can be very high and the maximum throughput can thus be very low. In order to meet the demand for finer fibres and higher throughputs, the single-row nozzle has indeed also been subjected to further developments, as described in U.S. Pat. Nos. 6,245,911 and 7,316,552, but the design already reaches its limits geometrically and in terms of manufacturing technology. For example, in the course of the development, the distance between the extrusion capillaries has been progressively reduced in order to increase the throughput per nozzle, but this has also led to increased expenditure and precession in the manufacture of the nozzle parts, as well as to a higher risk of spinning defects during operation. The throughput of a single-row nozzle ranges from 10 kg/h/m to 100 kg/h/m, depending on the melt or, respectively, the solution which is used and the operating parameters which have been chosen.

In order to increase the throughput, the multi-row needle nozzle as described in U.S. Pat. No. 4,380,570 has been developed. Therewith, the melt or, respectively, the solution is extruded through a nozzle with several rows and gaps, via hollow needles. Due to the resulting needle field, the throughput per nozzle can be increased in comparison to a single-row nozzle.

A disadvantage is that the hollow needles must be held by a complex support plate so that they will not vibrate or be bent too much by the surrounding gas stream. Damage to the delicate needles during manufacture and assembly is a constant hazard. Depending on the extent of damage, the repair may be very costly and may be performed only with special production tools such as laser drills and laser welders. The support plate also causes additional production expenditure and, besides, a pressure drop of the gas stream in the nozzle.

At the lower end of the nozzle, the hollow needle protrudes through a gas flow outlet plate. The gas flow outlet plate is necessary for distributing the gas stream evenly around the hollow needles and for accelerating to high discharge velocities. In the simplest case, a gas flow outlet hole is arranged around each hollow needle, from which the hot gas stream exits and entrains the filaments. This nozzle design indeed achieves throughputs in the range of 10 kg/h/m to 500 kg/h/m, but production, assembly, operation and cleaning are very complex. The design also fails to provide the necessary flexibility for being adapted to various raw materials, while still achieving high throughputs. In U.S. Pat. Nos. 5,476,616, 7,018,188 and 6,364,647, optimizations have already been made to the design of the hollow needles, the support plate and the gas outlet plate, but even with those optimized designs, the risk of leaks due to the numerous parts and of damaged needles is very high. Since the needles may, for example, have a length of between 20 mm and 70 mm, the pressure loss within the needle nozzle is higher than in the single-row nozzle. In longer nozzles, this leads to statics-related problems due to deflection. However, for economic reasons, the development should be geared towards longer nozzles with lengths of up to 5 m and beyond in order to increase the working width, the throughput and the cost-effectiveness of the installations.

In addition to the nozzle types already mentioned, there are alternative designs such as the Laval nozzle according to U.S. Pat. No. 7,922,943, which, however, is also composed of many individual parts and does not meet the requirement for high throughputs as well as ease of manufacture and assembly.

Since, so far, neither single-row nor multi-row nozzles have had a design that can be manufactured, assembled and operated with little effort, and since there is a demand for higher throughputs, longer nozzles, lower operating costs and at least consistent qualities of nonwoven materials made of a wide variety of raw materials, it is the object of the present invention to meet the requirements which have arisen by means of a new nozzle design:

The present invention aims to simplify the production, assembly and operation of the nozzle as much as possible, while expanding the freedom of design as far as possible toward the extrusion capillary, the discharge geometry of the extrusion opening and the airflow, for the production of different fibre geometries and nonwoven fabrics.

Another objective of the present invention consists in minimizing the pressure loss both on the part of the melt or, respectively, the solution, and on the part of the gas stream. This is supposed, on the one hand, to increase the throughput per metre of nozzle length and, on the other hand, to reduce the deflection of the nozzle in order to be able to manufacture longer nozzles with little effort.

According to the present invention, the present object is achieved in that the extrusion capillaries are arranged in extrusion columns which protrude from a base plate and are formed in one piece with said base plate.

Furthermore, the present object is achieved by a method of manufacturing the device for the extrusion of filaments.

Preferred embodiments of the present inventions are described in the subclaims.

The device according to the invention comprises extrusion columns formed in one piece with the base plate, wherein the base plate and the extrusion columns are jointly formed in one piece from a base material. This new type of nozzle is composed of sturdy extrusion columns which enable minor pressure losses and high throughputs on the part of the melt or, respectively, the solution due to a multi-row design and large diameters.

The device according to the invention can be produced from a base material block by manufacturing methods from the field of subtractive production, such as, for example, milling or etching. For example, the base material may be a metal. Further subtractive production methods will be apparent to a person skilled in the art from this exemplary reference. Alternatively, the device according to the invention can be produced by manufacturing methods from the field of additive production, such as, for example, three-dimensional printing methods. Selective laser melting and fused deposition modelling are to be mentioned by way of example. Further additive production methods will become apparent to a person skilled in the art from this exemplary reference. Furthermore, the device according to the invention can be produced by primary shaping or forming, e.g., by casting.

Nevertheless, the extrusion orifice may have a small design and be configured in various geometries in order to produce fine fibres and filaments in a wide variety of shapes with small quantities of air.

To better illustrate the invention, the essential features are shown in the following figures on the basis of preferred embodiments of the device according to the invention:

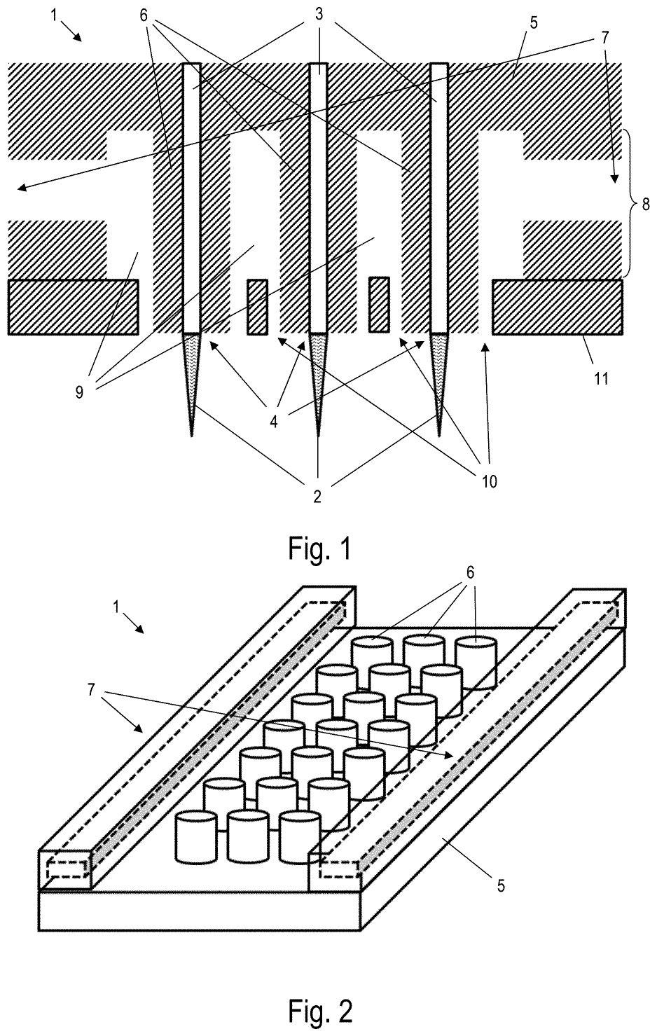

FIG. 1 shows a schematic side view of the device according to the invention with extrusion columns, extrusion capillaries, gas supply openings and a gas flow distributor.

FIG. 2 shows the device according to the invention in a perspective illustration.

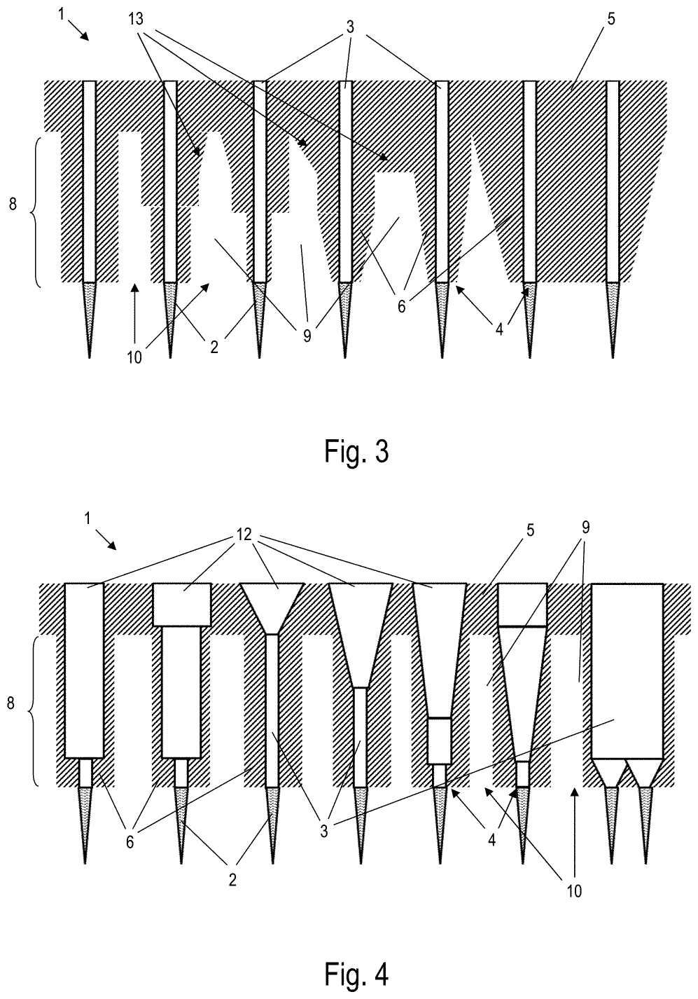

FIG. 3 shows various shapes of the external geometry of extrusion columns of the device.

FIG. 4 shows various shapes of the internal geometry of the extrusion capillaries of the device.

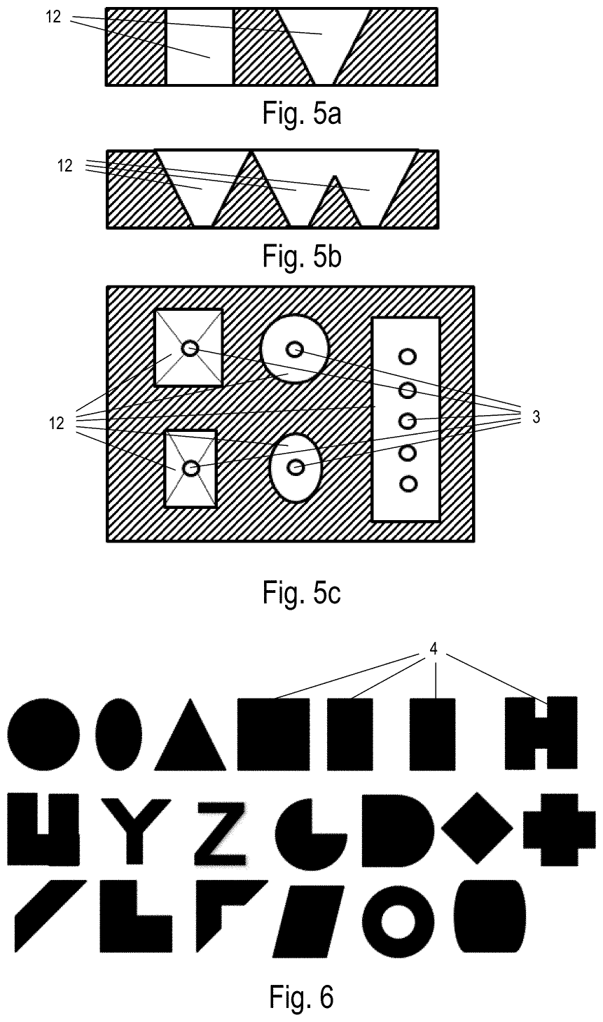

FIG. 5a and FIG. 5b show various design forms of the geometry of an inlet section in schematic side views.

FIG. 5c shows various design forms of the geometry of an inlet section and the arrangement of extrusion capillaries in a plan view.

FIG. 6 shows various shapes of extrusion openings at the outlet of the extrusion capillaries.

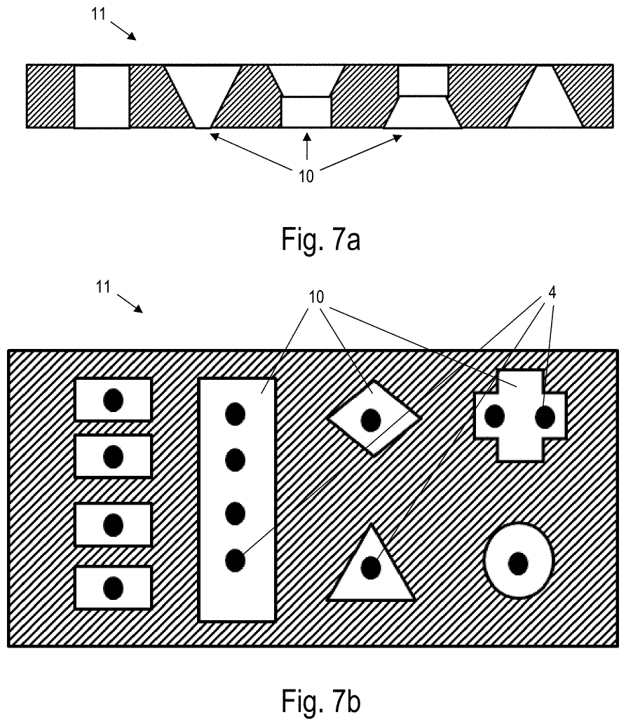

FIG. 7a shows a gas flow outlet plate for influencing the air current at the outlet and various geometries of the gas outlet openings in a schematic side view.

FIG. 7b shows a gas flow outlet plate for influencing the air current at the outlet and various geometries of the gas outlet openings in a schematic plan view.

FIG. 1 shows a schematic side view of a preferred embodiment of the device 1 according to the invention for the extrusion of filaments 2. The device 1 has a plurality of extrusion capillaries 3 arranged in at least two consecutive rows. The extrusion capillaries 3 have extrusion openings 4 for the extrusion of a spinning solution, whereby filaments 2 are formed. The device 1 furthermore comprises a plurality of means or components 7, 8, 10 for the generation of a gas stream for producing a gas stream oriented essentially in the direction of the extrusion of the filaments 2 at least in the area of the extrusion openings 4. In the device 1 according to the invention, the extrusion capillaries 3 are arranged in extrusion columns 6 which protrude from a base plate 5 and are formed in one piece with said base plate 5. The device 1 is also referred to as a column nozzle.

The means 7, 8, 10 for the generation of a gas stream include a gas flow distributor 8, which is not illustrated further, and at least two gas supply openings 7, which are arranged adjacent to the base plate 5. According to a further embodiment of the device, the means for the generation of a gas stream also include gas outlet openings 10, which are illustrated in FIGS. 7a and 7b. The gas supply openings 7 are located opposite to each other and are configured so as to produce a gas stream oriented essentially vertically to the direction of the extrusion of the filaments 2 in the area of the gas supply openings 7.

FIG. 1 furthermore shows the device 1 comprising extrusion columns 6, extrusion capillaries 3 and gas flow ducts 9. At the top, the melt or, respectively, the solution enters into the extrusion capillary 3 and is extruded at the bottom as a filament 2. The gas stream enters the gas flow distributor 8 laterally via the gas supply openings 7 and is conveyed to the individual extrusion columns 6 in a gas flow duct 9 and deflected toward the extrusion opening 4 by means of the extrusion columns 6.

It has been shown that the device 1 according to the invention as shown in FIG. 1 can be manufactured in one piece. All of the geometries required for the production of the spunbonded web can be incorporated into a block of base material using a wide variety of manufacturing methods or, respectively, arise jointly from the base material during the manufacture, for example, by casting or by additive production methods. In this case, the internal geometry of the extrusion columns 6 is important for the extrusion conditions of the melt or, respectively, the solution, since the pressure loss can be drastically reduced.

Surprisingly, it has been shown that the production of nonwoven fabrics from melts and solutions works with the present invention also without gas flow outlet plates (which are necessary in prior art devices). The external geometry of the extrusion columns 6 and their arrangement with respect to each other, i.e., the shape of the gas flow duct 9 resulting therefrom, is sufficient for redirecting the gas stream, for accelerating it and for drawing the extruded filaments 2.

According to the invention, support plates are not required, either, since the extrusion columns 6 are stable enough and cannot be bent or caused to vibrate by the gas stream.

The melt or, respectively, the solution enters into the extrusion capillary 3 and flows as far as to the extrusion opening 4. At the same time, a gas stream is supplied on both longitudinal sides of the device 1 via the gas flow distributor 8 and the gas supply openings 7 essentially vertically to the direction of the extrusion of the filaments. The gas stream is guided through the gas flow duct 9 formed between the extrusion columns 6. Since the gas streams collide from the two sides, they are guided and accelerated along the extrusion columns 6 toward the extrusion opening 4. Upon exiting the extrusion capillary 3, the extruded melt or, respectively, solution filament is entrained and drawn by the hot gas stream at high speed. Because of the turbulence of the gas stream, the drawn filaments 2 are placed in a random arrangement and deposited as a nonwoven fabric on a drum or, respectively, on a conveyor belt (not illustrated).

An advantage of the device 1 is that, in contrast to a needle nozzle, it can be manufactured from the base material in one piece or, respectively, from a base material block, and that no long, thin tubes need to be inserted into a plate and welded or glued in a complicated way. The gas flow ducts 9 are removed mechanically, for example, and this results simultaneously in the extrusion columns 6. This simplifies the manufacture of the device 1 and increases stability. As a result, the manufacture and installation of support plates is not necessary, either. Moreover, there is no longer the risk of needles being bent during the manufacture or assembly of the device 1.

Via the gas flow ducts 9, the gas stream entering via the gas flow distributor 8 is guided and accelerated toward the extrusion opening 4. Surprisingly, it has been shown that this deflection through the gas flow ducts 9 at 0.1 to 3 bar, preferably at 0.3 to 1.5 bar, more preferably at 0.5 to 1.0 bar, gas stream pre-pressure, leads to speeds of 20 to 250 m/s at the extrusion opening 4, without the need of using a gas flow outlet plate. As a result, also nonwoven fabrics can be produced with the device 1 without conveying the gas through a gas flow outlet plate 11. Thus, a further nozzle part can be omitted so as to reduce the effort associated with manufacturing, assembling and operating the device 1.

In addition, a gas outlet plate 11 is provided in FIG. 1. Gas outlet plates 11, in particular with a wide variety of geometries, see FIG. 7, can optionally be used in addition in order to influence the drawing of the filaments 2, the deposition of the nonwoven material, the product quality and the required gas quantity.

As shown in FIG. 1 and FIG. 7, in these gas outlet plates 11, gas outlet openings 10 arranged in the area of the extrusion openings 4 may optionally be provided in addition to the gas supply openings 7. The gas outlet openings 10 may be designed either for the production of a gas stream oriented in the direction of the extrusion or, in case that gas supply openings 7 are already provided adjacent to the base plate, may be configured for discharging the gas stream already generated by the gas supply openings 7 in the direction of the extrusion.

In one embodiment of the device 1, the gas outlet plate 11 is thereby formed in one piece with the base plate 5 and the extrusion columns 6. These are, in turn, manufactured from the base material in one piece.

The device 1 manufactured in accordance with one of the previously described embodiments is fastened at the top to a melt or, respectively, solution distributor. The connection of the gas flow distributor 8 to the gas flow supply line may occur either on the longitudinal sides, on the broadside, or on the upper side of the device 1. Since the device 1 consists of a solid piece of base material, heating systems (e.g., hot water, oil, steam, electric heaters, . . . ) can also be installed with little effort in order to improve the spinning stability and to increase the consistency of the quality of the nonwoven fabric.

The gas flow supply via the gas flow distributor 8 to the extrusion columns 6 takes place uniformly over the two longitudinal sides of the device 1, as shown in FIG. 2. FIG. 2 shows that the entire device 1 can be manufactured in one section, as described herein. In case of larger devices, it is, of course, also possible to construct them from a plurality of sections (not illustrated) which have been manufactured as described herein and can be interconnected in the usual way to form a device. Each section thereby forms a segment of the entire device 1, with the above-described manufacturing and operating advantages being preserved in their entirety in comparison to the devices of the prior art.

Many geometries and variations are possible for the production of the section or the sections. The extrusion capillaries 3, which are not illustrated in FIG. 2, can be drilled, for example, whereas the extrusion columns 6 can be milled from the base material block or can be cast with the section. Depending on the geometry, other manufacturing methods are possible as well. The extrusion columns 6 can also be arranged in groups over the width of the device 1 as long as the gas flow distribution is ensured. In this case, the height and the shape of the outlet from the gas flow distributor 8, which is not illustrated in FIG. 2, may vary. The height of the outlet duct should range from 5 mm to 100 mm, preferably from 10 mm to 50 mm, more preferably from 15 mm to 30 mm. The length of the gas flow distributor 8 should extend at least from the outermost row of extrusion columns on one side to the last row of extrusion columns on the opposite side so that all the extrusion columns 6 are supplied evenly with the gas stream. In this connection, it may be necessary for stability reasons that the gas flow distributor 8 must be interrupted by webs in order to ensure the stability of the component. Furthermore, it has become apparent that it is reasonable to polish the surface of the parts carrying the gas stream in order to minimize turbulences prior to the discharge from the gas flow distributor 8. The outlet geometry of the gas flow distributor 8 can be manufactured in various shapes. Some examples are a continuous rectangular slot, several intermittent rectangular slots and several circular, trapezoidal, triangular cross-sections. In addition to the examples mentioned, further geometries, combinations of said geometries and different geometries are possible for the device 1.

Part of the gas stream emerging from the gas flow distributor 8 via the gas supply openings 7 impinges on the first row of extrusion columns and is deflected toward the extrusion opening 4. The remainder of the gas stream flows in the gas flow duct 9 between the extrusion columns 6 in the inner rows until it impinges on the gas stream from the other device side. This apparently creates a congestion cone which guides the gas stream along the inner rows of extrusion columns as far as to the extrusion outlet. This deflection effect already works with one row of extrusion columns. The number of rows of extrusion columns that can be supplied with the gas stream without the need for an additional gas outlet plate 11 ranges, for example, between one and thirty rows, preferably between two and twenty rows, more preferably between three and eight rows, depending on the extrusion column design and the gas duct width. In addition to the examples mentioned, further geometries, combinations of said geometries and different geometries are possible for the device 1.

FIG. 3 shows that the external geometry of the extrusion columns 6 can assume a variety of shapes. Depending on the shape of the extrusion columns 6, a different shape of the gas flow duct 9 arises, and the gas stream is deflected differently. Guide wedges for influencing the stream can also be formed in the gas flow duct 9.

In order to promote the deflection of the gas stream, the external geometry and the arrangement of the extrusion columns 6, as illustrated in FIG. 3, may be varied. In doing so, the external geometries may be designed, for example, in a continuous, staggered, multiply-staggered, cylindrical, conical fashion, as a cuboid, as an obelisk, as a pyramid, or as a combination of different geometries. The external geometry of the extrusion columns 6 is preferably selected from the group consisting of cylindrical, conical, cuboidal, obelisk-shaped, pyramid-shaped or mixtures thereof “Mixture” means that the external geometry changes over the length of the extrusion column. For example, the extrusion column 6 may be cylindrical over most of its length but configured as a cone at its tip.

The extrusion columns 6 may have either equal or different lengths in order to produce variations in the fineness of the fibers.

The length of an extrusion column 6 from foot to tip may be between 10 mm and 200 mm, preferably between 20 mm and 100 mm, more preferably between 30 mm and 60 mm. For cylindrical extrusion columns 6, the external diameter, depending on the internal geometry of the extrusion capillary 3 and the length of the extrusion column 6, may be between 3 mm and 30 mm, preferably between 6 mm and 20 mm, more preferably between 9 mm and 15 mm. For conical extrusion columns 6, the diameter of the footprint may be between 3 mm and 30 mm, preferably between 6 mm and 20 mm, more preferably between 9 mm and 15 mm. The tip of the cone can taper to a diameter of 0.1 mm. In cuboidal extrusion columns 6, obelisks and pyramids, the side length is between 3 mm and 30 mm, preferably between 6 mm and 20 mm, more preferably between 9 mm and 15 mm. In addition to the examples mentioned, further geometries, combinations of said geometries and different geometries are possible for the device 1.

The extrusion columns 6 can additionally be heated or cooled in order to improve the spinning stability.

FIG. 3 shows that the gas flow duct 9 between the extrusion columns 6 can be changed by flow wedges 13, gradations and other geometries in order to optimize the deflection of the gas stream. Depending on the total length of the device 1, the number of rows, the width and the geometries of the extrusion columns 6, the width of the gas flow duct 9 results. The width of the gas flow duct 9 ranges from 1 mm to 50 mm, preferably from 2 mm to 40 mm, more preferably from 3 mm to 30 mm. Within one gap, the gas flow duct 9 between the extrusion columns 6 can be omitted. This results in a wide extrusion column 6 comprising several extrusion capillaries 3. It has become apparent that the surfaces of the extrusion columns 6 and the gas flow duct 8 should be polished in order to minimize turbulences. In addition to the examples mentioned, further geometries, combinations of said geometries and different geometries are possible for the device 1.

As per a preferred embodiment of the device 1 according to the invention, one extrusion capillary 3 is provided per extrusion column 6. In an alternative embodiment, the device 1 has at least one extrusion column 6, in which two or more extrusion capillaries 3 are arranged. The device 1 shown in FIG. 3 has, for example, two completely separate extrusion capillaries 3 with associated extrusion openings 4, which are arranged in a common extrusion column 6.

In principle, embodiments with a high number of extrusion capillaries 3 per extrusion column 6 are possible as well. In this way, the advantage is obtained that the device is suitable for the production of a plurality of different spunbonded webs from a wide variety of materials.

FIG. 4 shows that the internal geometry of the extrusion capillaries 3 can assume a variety of shapes. Depending on the shape, the flow of the melt or, respectively, the solution is affected differently, and the pressure loss and the spinning behaviour are changed.

Since the extrusion columns 6 occupy more space than, for example, the needles of a multi-row needle nozzle of the prior art, the throughput per hole must be much higher in order to achieve the necessary throughputs. For this, the geometry of the extrusion capillary 3 must be adapted to the rheological properties of the materials used. FIG. 4 shows that, in the device 1, the geometry of the extrusion capillaries 3 can be varied as needed in order to reduce the pressure drop for various melts and solutions as much as possible for high throughputs. In this case, the extrusion capillaries 3 may be designed, for example, in a continuous, staggered, multiply-staggered, cylindrical, conical fashion, as a cuboid, as an obelisk, as a pyramid, or as a combination of different geometries. For example, an extrusion capillary 3 may be cylindrical over most of its length, but the tip may be configured as a cone. The tip of the cone can taper to a diameter of 0.09 mm. The extrusion capillaries 3 may have either equal or different lengths in order to produce variations in the fineness of the fibres. As already mentioned, the extrusion capillaries 3 can additionally be heated or cooled in order to improve the spinning stability. As shown in FIG. 4, according to a preferred embodiment of the device 1, the extrusion capillaries 3 exhibit an inlet section 12 the geometry of which differs from that of the remaining sections of the extrusion capillary 3.

According to a further embodiment of the device 1, at least one extrusion capillary 3 has, for example, two or more extrusion openings 4, as shown by way of example in FIG. 4.

FIGS. 5a, 5b and 5c show that the inlet geometry of the inlet section 12, the cross-section and the arrangement or, respectively, the overlap of the extrusion capillaries 3 may vary greatly. In FIGS. 5a to 5c, various variations of the geometry of the inlet section 12 of the extrusion capillaries 3 are illustrated, wherein FIG. 5a and FIG. 5b show different geometries of the inlet section 12 in a side view, and FIG. 5c shows a plan view of different inlet sections 12. The geometry of the inlet section 12 of the extrusion capillaries 3 can be varied as needed in order to reduce the pressure drop for various melts and solutions as much as possible for high throughputs. FIG. 5a and FIG. 5b show in a side view that the geometry of the inlet section 12 can be designed in a cylindrical or conical fashion. It has been shown that a distance or an overlap of the geometries of the inlet section 12 may exist between the individual inlet shapes. In the plan view of FIG. 5c, it is illustrated that the geometry of the inlet section 12 of the extrusion capillary 3 may also be square, rectangular, circular and elliptical. In addition to the examples mentioned, further geometries, mixtures of said geometries and different geometries are possible for the device 1. “Mixture” again means that the geometry of the inlet section 12 changes over its length. Furthermore, FIG. 5c shows that several extrusion openings 4 can be supplied by a common inlet section 12. Said inlet section 12 can also supply an extrusion capillary 3 to which those extrusion openings 4 are connected.

FIG. 6 shows various shapes of the extrusion opening 4 at the outlet of the extrusion capillary 3. The extrusion opening 4 at the outlet of the extrusion capillary 3 can be shaped very differently. This results in different filament geometries and product properties. The extrusion opening 4 of the extrusion capillary 3 dictates the cross-sectional shape of the extruded filament 2 and can have a wide variety of geometries. As shown in FIG. 6, the extrusion opening 4 may be designed, among others, in a circular, elliptical, triangular, square, rectangular fashion, as a gap, as a semicircle, as a crescent, as a star, as a trapezoid, as an L-shape, as a T-shape, as a U-shape, as a Y-shape or as a Z-shape. Furthermore, the extrusion opening 4 may also be designed in the form of an H. The diameter of a circular extrusion opening 4 may range between 90 μm and 700 μm, preferably between 150 μm and 500 μm, more preferably between 200 μm and 400 μm. In addition to the examples mentioned, further geometries, combinations of said geometries and different geometries are possible for the device 1.

FIG. 7a shows a gas flow outlet plate 11 in a schematic side view, and FIG. 7b shows a further gas flow outlet plate 11 in a plan view. The gas flow outlet plate 11 can be used for influencing the air current at the outlet. In the geometry of the gas outlet openings 10, many different variants are possible. This provides the possibility of generating further variations in the forming of filaments and the production of nonwoven materials. The geometry of the gas outlet opening 10 may, for example, be circular, rectangular, square, or triangular. In case of circular gas outlet openings 10, the diameter ranges from 1 mm to 15 mm, preferably between 1.5 mm and 10 mm, more preferably between 2 mm and 8 mm. The holes may be conical or cylindrical, for example. The gas emission can take place before or after the extrusion opening 4. The gas outlet opening 10 may surround one or more extrusion openings 4. In addition, further gas outlet openings 10 may be present in the gas flow outlet plate 11 without surrounding an extrusion opening 4. The gas flow outlet plate 11 can also be formed from a plurality of plates, pins, beams and wires. In addition to the examples mentioned, further geometries, combinations of said geometries and different geometries are possible for the device 1.

According to an embodiment of the device 1, at least part of the extrusion columns 6 of the device 1 according to the invention may differ from another part of the extrusion columns 6 in at least one property selected from the length of the extrusion column 6, the external geometry of the extrusion column 6, the external diameter of the extrusion column 6, the existence of an inlet section 12 of the extrusion capillary 3, the geometry of the inlet section 12 and the geometry of the extrusion openings 4.

In a further embodiment, the device 1 has a substantially rectangular basic shape. As a result, productional advantages are achieved.

FIG. 7b furthermore shows that several extrusion openings 4 can be supplied via the same gas flow outlet opening 10. The extrusion openings 4 located within a gas flow outlet opening 10 are extrusion openings 4 toward a common extrusion column 6, which is not illustrated in FIG. 7b.

The invention as described was an improvement over known nozzles in terms of production expenditure, variety of design, throughput, assembly, scalability to large lengths, and operation. As raw materials, the polyolefins already used for other meltblown processes can be used as homopolymers and co-polymers (e.g., EVA), as well as terpolymers, polyesters, polyamides, polyvinyls, nylon, PC, and other suitable raw materials. Polyolefins such as PP, PE, LDPE, HDPE, LLDPE are used preferably as homopolymer or co-polymer. Cellulose acetate, starch solutions and Lyocell solutions may also be used with the present invention and the above-mentioned advantages for the production of filaments and spunbonded fabrics.

The device 1 can thus be used for the extrusion of filaments 2 and for the production of spunbonded webs from a wide variety of polymeric materials. These include in particular melts of thermoplastics such as polypropylene, polystyrene, polyester, polyurethane, polyamide, EVA, EMA, EVOH, fusible copolymers, PBT, PPS, PMP, PVA, PLA or Lyocell spinning dope, the use of Lyocell spinning dope being particularly preferred.

The generic name “Lyocell” has been awarded by BISFA (The International Bureau for the Standardisation of Man Made Fibres) and denotes cellulose fibres made from solutions of cellulose in an organic solvent. Tertiary amine oxides, in particular N-methyl-morpholine-N-oxide (NMMO), are preferably used as solvents. A method of producing Lyocell fibres is described, for example, in U.S. Pat. No. 4,246,221 A. Other possible solvents are often summarized under the collective term “ionic liquids”.

As already mentioned, in the production of nonwoven fabrics with the device 1, the melt or, respectively, the solution is pumped through the device 1, drawn with hot air and deposited as a nonwoven fabric on a drum or a conveyor belt. Depending on the raw material, the produced nonwoven material can either be wound up directly, or it must first be washed, aftertreated and dried. Depending on the raw material used, the design of the present invention can be adapted such that temperatures between 20° C. and 500° C., preferably from 50° C. to 400° C., more preferably between 100° C. and 300° C., can be operated as long as the raw material and the produced nonwoven material are not damaged by the temperature. According to the invention, the device 1 can have such a solid design that, on the part of the melt, pressures between 10 bar and 300 bar, preferably between 20 bar and 200 bar, more preferably between 30 bar and 150 bar, can take effect. The throughputs of the melt or, respectively, the solution and of the gas stream required for the production of the nonwoven material can vary greatly depending on the raw material used, the distance between the device 1 and the depot, the nozzle design and the applied temperature. The usual throughput of the melt or, respectively, the solution per extrusion hole ranges from 1 g/hole/min to 30 g/hole/min, preferably from 2 g/hole/min to 20 g/hole/min, more preferably between 3 g/hole/min and 10 g/hole/min. For a device 1 with a length of 1 m, 6 rows and 100 gaps, this corresponds to a throughput of 1080 kg/h/m. As a result, the throughput of the device 1 is higher than in the needle nozzle and much higher than in the single-row nozzles. The usual range for the amount of the gas stream in kg of gas per kg of melt or, respectively, solution is between 10 and 300 kg/kg, preferably from 20 kg/g to 200 kg/kg, more preferably between 30 kg/kg and 100 kg/kg. Since the device 1 can be constructed with a length of up to 5 m and beyond, nonwoven widths of 5 m and beyond can be achieved. Depending on the design of the device, the raw material and the operating parameters, the manufactured products have fibre diameters of 1 μm to 30 μm, preferably 2 μm to 20 μm, more preferably between 3 μm and 10 μm. Depending on the throughput and the transport speed, nonwoven fabrics with a weight per unit area of between 5 g/m² and 1000 g/m², preferably between 10 g/m² and 500 g/m², more preferably between 15 g/m² and 200 g/m², can be produced with the device according to the invention.

The device 1 according to the invention for the extrusion of filaments 2 is produced in a method which comprises the step of manufacturing the base plate 5, the extrusion columns 6, optionally the gas supply openings 7 and furthermore optionally the gas outlet plate 11 by forming them jointly in one piece from a base material.

1. A device for the extrusion of filaments comprising a plurality of extrusion capillaries arranged in at least two consecutive rows and having extrusion openings for extruding a spinning solution, whereby the filaments are formed, and a plurality of components for the generation of a gas stream for producing a gas stream oriented essentially in the direction of the extrusion of the filaments at least in the area of the extrusion openings, wherein the extrusion capillaries are arranged in extrusion columns which protrude from a base plate and are formed in one piece with said base plate.

2. The device according to claim 1, wherein the components for the generation of a gas stream include at least two gas supply openings, which are arranged adjacent to the base plate, are located opposite to each other and are configured so as to produce a gas stream oriented essentially vertically to the direction of the extrusion of the filaments in the area of the gas supply openings.

3. The device according to claim 1, wherein the external geometry of the extrusion columns is cylindrical, conical, cuboidal, obelisk-shaped, pyramid-shaped or mixtures thereof.

4. The device according to claim 1, wherein the extrusion capillaries exhibit an inlet section the geometry of which differs from that of the remaining sections of the extrusion capillary.

5. The device according to claim 4, wherein the geometry of the inlet section is cylindrical, conical, square, rectangular, circular, elliptical and mixtures thereof.

6. The device according to claim 1, wherein the geometry of the extrusion openings is circular, elliptical, triangular, square, rectangular, T-shaped, H-shaped, U-shaped, Y-shaped or Z-shaped.

7. The device according to claim 1, wherein at least part of the extrusion columns differs from another part of the extrusion columns in at least one property selected from
the length of the extrusion column
the external geometry of the extrusion column
the external diameter of the extrusion column
the existence of an inlet section of the extrusion capillary
the geometry of the inlet section
the geometry of the extrusion openings.

8. The device according to claim 1, wherein the components for the generation of a gas stream optionally include, in addition, gas outlet openings arranged in the area of the extrusion openings and designed for the production of a gas stream oriented in the direction of the extrusion or, in case that gas supply openings are provided adjacent to the base plate, configured for discharging the gas stream in the direction of the extrusion.

9. The device according to claim 8, wherein the device comprises a gas outlet plate, with the gas outlet openings being formed in the gas outlet plate.

10. The device according to claim 9, wherein the gas outlet plate is formed in one piece with the base plate and the extrusion columns.

11. The device according to claim 1, wherein the device has an essentially rectangular basic shape.

12. The device according to claim 1, wherein one extrusion capillary is provided per extrusion column.

13. The device according to claim 1, wherein the device comprises at least one extrusion column in which two or more extrusion capillaries are provided.

14. The use of a device according to claim 1 for the extrusion of filaments and for the production of spunbonded fabrics from various polymeric materials.

15. The method of producing a device according to claim 1, comprising the step of manufacturing the base plate, the extrusion columns and optionally the gas supply openings as well as optionally the gas outlet plate by forming them jointly in one piece from a base material.

16. The use according to claim 14, wherein the various polymeric materials are from melts of thermoplastics such as polypropylene, polystyrene, polyester, polyurethane, polyamide, EVA, EMA, EVOH, fusible copolymers, PBT, PPS, PMP, PVA, PLA or Lyocell spinning dope.

17. The use according to claim 16, wherein the polymeric material is a Lyocell spinning dope.
